(19) United States
(12) Patent Application Publication
(10) Pub. No.: US 2003/0236181 A1
(43) Pub. Date: Dec. 25, 2003

(54) Fabric softeners and treatment agents and methods of use thereof

(76) Inventors: Marie Chan, Forest City, NC (US); James Spry, Spartanburg, SC (US); Howard Childress, Spartanburg, SC (US)

Correspondence Address: Milliken & Company, P.O. Box 1927, Spartanburg, SC, 29304, US

(21) Appl. No.: 10/174,777

(22) Filed: Jun. 19, 2002

(51) Int. Cl. D06L 1/00; C11D 3/00

(52) U.S. Cl. 510/515

(57) ABSTRACT

Specific types of compounds that impart highly effective softening, antistatic, and ironability characterostics to and for various types of launderable fabrics (such as garments, tablecloths, draperies, and the like) through a rinse-cycle application within a standard machine laundering process are provided. Such compounds provide effective lubricity to target fibers as well as simultaneous static dissipative characteristics either alone or, as one preferred embodiment, in combination with other typical fabric softening agents. Such a composition comprising or method utilizing such compounds thus provides a relatively simple, yet highly effective manner of imparting these highly desired properties to fabrics. A fabric treated with such compounds or in accordance with this method is also provided.

### FIELD OF THE INVENTION

This invention relates to specific types of compounds that impart highly effective softening, antistatic, and ironability characteristics to and for various types of launderable fabrics (such as garments, tablecloths, draperies, and the like) through a rinse-cycle application within a standard machine laundering process. Such compounds provide effective lubricity to target fibers as well as simultaneous static dissipative characteristics either alone or, as one preferred embodiment, in combination with other typical fabric softening agents. Such a composition comprising or method utilizing such compounds thus provides a relatively simple, yet highly effective manner of imparting these highly desired properties to fabrics. A fabric treated with such compounds or in accordance with this method is also provided.

### DISCUSSION OF THE PRIOR ART

All U.S. patents cited below are herein fully incorporated by reference.

Fabric softener compositions are known in the art and are used in rinse cycles of automatic laundry operations to impart improved texture and anti-static properties to laundered fabrics. The first U.S. concentrated (6-10% active) rinse cycle fabric softener was introduced in the 1960s. These were added during the final rinse of the wash cycle and were usually quaternary types, mainly di (hydrogenated) tallow dimethylammonium chloride (DHTDMAC) and diester tallow quats (DEETMAC), although some were based on imidazoline or amido amine derivatives. The products were essentially aqueous solutions or suspensions containing 4-6% active softener, a fabric substantive fragrance and a viscosity modifier. In 1990, ultra formulations, (17-28% solids), e.g., “triple concentrates,” were introduced in the U.S. and are increasing in the marketplace owing to their reduced packaging and transportation costs. Such formulations require particular care in ingredient formulation, mixing, viscosity control, and final formulation viscosity stability in order to provide stable, low viscosity products. See, e.g., “Formulation and Production of Concentrated Rinse Cycle Fabric Softeners,” Robert 0. Keys, happi/March 1995, pp. 95-97, and “Fabric Conditioning Agents,” George R. Whalley, happi/February 1995, pp. 55-58. Recently, formulations have reduced or replaced DHTDMAC, e.g., with ester quats (such as DEETMAC) or ester amines, in order to facilitate product breakdown in the ecosystem, particularly in Europe. These formulations also require special considerations to provide a commercial product of the proper viscosity.

Although such common fabric softener compounds and compositions provide certain desired benefits to the user, there are also drawbacks and limitations that have led and continue to lead to further developments in this area. For example, although treatment of certain fabrics, for example, cottons, with such aforementioned quaternary ammonium systems and compounds provide excellent softening, the same cannot always be said for treatment of polyester-based fabrics. Furthermore, static build-up generally leads to static adhesion of different types of garments and fabrics after drying in a standard rotary dryer machines. However, static dissipation is not always effective upon inclusion of quaternary ammonium compounds within rinse cycle treatments. Additionally, ironability of fabrics, such as through reduction of friction to fabric surfaces, is not always obtained through utilization of quaternary ammonium compounds and compositions either. Toxicity and biodegradability issues are further issues concerning amine and/or quaternary ammonium compounds and/or compositions, particularly within rinse cycle procedures wherein the residual treatment compositions must be disposed of into a sewer system or septic system. As a result, there is clearly a need for development of either a total or partial substitute for such quaternary ammonium types of fabrics softening agents. To date, nothing has been disclosed that concerns a non-nitrogenated compound to fulfill each of these desirable characteristics either alone or in combination with other standard cationic softening agents.

### SUMMARY AND DESCRIPTION OF THE INVENTION

It is thus an object of this invention to provide a rinse-cycle composition comprising a fabric softening, static dissipative, ironability improving compound that is non-nitrogenated in nature. A further object of this invention is to provide an improvement in terms of either a full substitute or an additive for quaternary ammonium-based fabric softening compositions such that the replacement composition or additive-containing composition exhibits at least improved softening, ironability, or static dissipation over the quaternary ammonium-based composition alone.

Accordingly, the present invention encompasses a fabric softener composition comprising:

1) from 0.1 to 90% by weight of at least one cationic (preferably a quaternary ammonium-based) fabric softener compound;

2) from 0.001 to about 99.99% by weight of a liquid carrier; and

3) at least one fiber lubricant/plasticizer selected from the group of lubricating/plasticizing agents consisting of at least one compound that conforms with the following Formula (A)

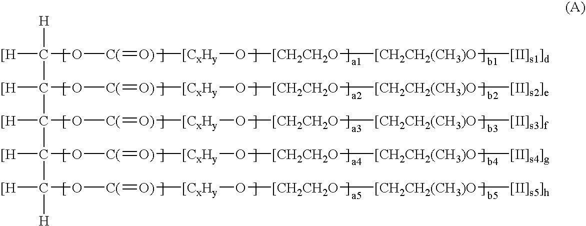

wherein d=f=h=1; e=0 or 1; g=0 or 1; 2≦x≦20; (2x−4)≦y≦2x; and Σaᵢ>=8 and

$$\frac{Σ {a}_{i} ( 44 )}{Σ {a}_{i} ( 44 ) + Σ {b}_{i} ( 56 )} >= 0.6 ;$$

wherein structure [II] is H, CH₃, or

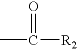

wherein R₂=CₚH_{q} such that 1≦p≦20, 2p−3≦q≦2p+1, and sᵢ=0 or 1; at least one compound that conforms with the following Formula (B)

(B)

[I]—[CH₂CH₂O]ₐᵢ—[CH₂CH₂(CH₃)O—]_{bi}—[II]ₛᵢ

wherein structure [I ] is H, CH₃O or R₁(O)_{c};

wherein R₁=CₙHₘ, and 2≦n≦20, (2n−4)≦m≦2n +1, 1≦c≦5, and

$$Σ {a}_{i} \geq 8 , and \frac{Σ {a}_{i} ( 44 )}{Σ {a}_{i} ( 44 ) + Σ {b}_{i} ( 56 )} >= 0.6 ;$$

wherein and Structure [II ] is H, CH₃, or

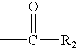

wherein R₂=CₚH_{q} such that 1≦p≦20, 2p−3≦q≦2p+1, and sᵢ=0 or 1; and any mixtures thereof. Preferably, such a fiber lubricant/plasticizer exhibits a hydrophilic/lipophilic balance (HLB) of greater than or equal to 6.0.

Furthermore, this invention encompasses a method of treating fabrics during a standard laundering procedure comprising the steps of:

a) providing a fabric within a rinse cycle of a standard mechanical rotary washing machine;

b) introducing a fabric softening composition within said rinse cycle, wherein said fabric softening composition comprises:

1) from 0 to 90% by weight of at least one cationic (preferably quaternary ammonium-based) fabric softener compound;

2) from 0.001 to about 99.99% by weight of a liquid carrier; and

3) at least one fiber lubricant/plasticizer selected from the group of lubricating/plasticizing agents consisting of at least one compound that conforms with the following Formula (A)

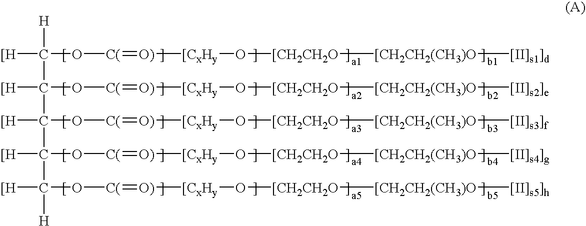

wherein d=f=h=1; e=0 or 1; g=0 or 1; 2≦x≦20; (2x−4)≦y≦2x; and Σaᵢ>=8 and

$$\frac{Σ {a}_{i} ( 44 )}{Σ {a}_{i} ( 44 ) + Σ {b}_{i} ( 56 )} >= 0.6 ;$$

wherein structure [II] is H, CH₃, or

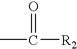

wherein R₂=CₚH_{q} such that 1≦p≦20, 2p−3≦q≦2p+1, and sᵢ=0 or 1; at least one compound that conforms with the following Formula (B)

(B)

[I]—[CH₂CH₂O—]ₐᵢ—[CH₂CH₂(CH₃)O—]_{bi}—[II]ₛᵢ

wherein structure [I ] is H, CH₃O, or R₁(O)_{c};

wherein R₁=CₙHₘ, and 2≦n≦20, (2n−4) ≦m≦2n+1, 1≦c≦5, and Σaᵢ≧8, and

$$\frac{Σ {a}_{i} ( 44 )}{Σ {a}_{i} ( 44 ) + Σ {b}_{i} ( 56 )} >= 0.6 ;$$

wherein and Structure [II ] is H, CH₃, or

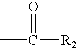

wherein R₂=CₚH_{q} such that 1≦p≦20, 2p−3≦q≦2p+1, and sᵢ=0 or 1; and any mixtures thereof. The fabric treated by such a method is also encompassed within this invention.

Although water is a required carrier component, other vehicles may be admixed therewith if desired including alcohols and other easily evaporated solvents. However, it is most highly preferred to have a simplified composition of water as the sole carrier component in order to provide an environmentally friendly formulation and to reduce the costs involved in producing such a composition.

In addition, other components may be present as well, including, without limitation, antistatic agents, preservatives, fragrances, perfumes, colorants, chelating agents, wetting agents, surfactants, antimicrobial agents, other fiber lubricating compounds, and the like. Of particular importance are physical property modifiers such as rheology, viscosity, and the like modifiers, in order to permit better spray-application of the liquid composition directly onto a target fabric surface. Relatively expensive and/or potentially toxic or regulated components such as silicones, cationic surfactants, methanol, ethanol, isopropanol, and the like, are discouraged (due to such cost and toxicity issues); however, they may be present if desired by the user such that their individual or collective presence is still within the scope of the invention as long as the required components of water and lubricant/plasticizer and optionally cationic softening agent are also present.

The all-important fiber lubricant/plasticizer is most broadly defined as any number of different nonionic compounds meeting the criteria set forth below for Formulae (A) or (B), as listed above, and any mixtures thereof. Of the particular nonionic species encompassed within this invention, alkoxylated fatty acid esters (such as alkoxylated stearic acid), alkoxylated fatty acid esters (such as ethoxylated esterified castor oil), emulsified high density polyethylenes, alkoxylated alcohols (such as ethylene oxide/propylene oxide block copolymers), as well as certain blends of such compounds with other compounds, such as phosphate salts, and the like, are preferred.

Sample, non-limiting, formulations of suitable quaternary ammonium- or amine-based fabric softener compositions to which the above-noted additive 3) is introduced of the present invention except are disclosed in U.S. Pat. No. 5,183,580 to Lew et al., U.S. Pat. No. 5,207,933 to Trinh et al., U.S. Pat. No. 5,204,010 to Klewsaat, U.S. Pat. No. 5,290,475 to Wixon, U.S. Pat. No. 5,130,035 to Dell'Armo et al., and U.S. Pat. No. 5,089,148 to Van Blarcom et al. The liquid fabric softener composition of the present invention includes 0 to 90 wt %, preferably from 0 to 45 wt % of a cationic fabric softening compound, preferably a quaternary ammonium compound. The counterion may be a halide, such as fluoride, chloride, bromide, or iodide. Other counterions may be employed such as methylsulfate, ethylsulfate, hydroxide, acetate, formate, sulfate, carbonate and the like. Preferably, the counterion is chloride or methylsulfate, chloride being especially preferred for liquid fabric conditioning compositions of the present invention. Generally, concentrated liquid fabric softener compositions of the present invention can contain from about 1% to 50% solids, more preferably from about 3.5% to about 25%, more preferably from about 3.5% to about 15%, and most preferably about 7% solids (active ingredient). Particulate base fabric softening compositions of the present invention can be prepared according to the formulation set out in U.S. Pat. No. 5,332,513 to Doms et al. for introduction within a rinse cycle during a standard fabric laundering procedure.

Examples of cationic quaternary ammonium salts suitable as an optional component within the inventive fabric softening compositions include, without limitation to:

(1) Acyclic quaternary ammonium salts having at least two C₈₋₃₀, preferably C₁₂₋₂₂ alkyl chains, such as: ditallowdimethyl ammonium chloride (Adogen 470™ from Witco), di(hydrogenated tallow)dimethyl ammonium chloride (Adogen 442™ from Witco), distearyl-dimethyl ammonium chloride (Varisoft TA-100™ from Witco), dicocodimethyl ammonium chloride (Variquat K300™ from Witco), modified tallow diester quat (DEETMAC, Stepantex GE-90TM from Stepan), and the like;

(2) Cyclic quaternary ammonium salts of the imidazolinium type such as di(hydrogenated tallow)-dimethyl imidazolinium chloride, 1-ethylene-bis(2-tallow-1-methyl) imidazolinium chloride (Varisoft 6112™ from Sherex) and the like;

(3) Diamido quaternary ammonium salts such as: methyl-bis(hydrogenated tallow amidoethyl)-2-hydroxyethyl ammonium methylsulfate (Varisoft 110™ from Sherex), methyl bis(tallowamidoethyl)-2-hydroxypropyl ammonium methylsulfate (Varisoft 238™ from Sherex) and the like;

(4) Biodegradable quaternary ammonium salts such as N,N-di(tallowoyl-oxy-ethyl) -N,N,-dimethyl ammonium chloride and N,N-di(tallowoyl-oxy-propyl)-N,N-dimethyl ammonium chloride. When fabric conditioning compositions employ biodegradable quaternary ammonium salts, pH of the composition is preferably adjusted to between 2 and 5. Biodegradable quaternary ammonium salts mentioned above are described more fully in U.S. Pat. Nos. 4,767,547 and 4,789,491. Biodegradable cationic diester compounds may also be employed of the type which have the formula:

(R₂C(O)OCH₂)(R₂C(O)O)CHCH₂⁺NR₃X⁻

wherein each R is a short chain C₁-C₆, preferably C₁-C₃ alkyl or hydroxyalkyl group, e.g., methyl (most preferred), ethyl, propyl, hydroxyethyl, and the like, benzyl or mixtures thereof; each R₂ is a long chain C₁₀-C₂₂ hydrocarbyl, or substituted hydrocarbyl substituent, preferably C₁₅-Cl₁₉ alkyl and/or alkylene, most preferably C₁₅-C₁₇ straight chain alkyl and/or alkylene; and the counterion, X⁻, can be any softener-compatible anion, for example, chloride, bromide, methylsulfate, formate, sulfate, nitrate and the like. These cationic diesters are described in greater detail in U.S. Pat. No. 4,137,180.

(5) Mixtures of water-insoluble cationic fabric softener and a polyalkoxylated ammonium salt as described in U.S. Pat. No. 4,422,949. Such mixtures may be particularly suitable for incorporation in concentrated liquid fabric softener compositions. Cationic nitrogenous salts having one long chain acyclic aliphatic C₈₋₃₀ aliphatic group, preferably C₁₂₋₂₂, may also be employed as the cationic fabric softening compound herein. Examples of these are set out in U.S. Pat. No. 5,183,580. These include acyclic quaternary ammonium salts, substituted imidazolinium salts, alklypyridinium salts, and alkanamide alkylene pyridinium salts.

The quaternary ammonium-based fabric softening component may include other fabric conditioning compounds in place of or in addition to the cationic fabric softening compounds described above. These include i) tertiary fatty amines, ii) reaction products of stearic acid and aminoethylethanolanine, iii) carboxylic acids having 8 to 30 carbon atoms and one carboxylic acid group per molecule, iv) esters of polyhydric alcohols such as sorbitan esters or glycerol stearate, v) fatty alcohol, ethoxylated fatty alcohols, alkyl phenols, ethoxylated alkyl phenols, ethoxylated fatty amines ethoxylated monoglycerides, ethoxylated di-glycerides, ethoxylated fatty amides (Varamide T55™ from Sherex), vi) mineral oils, and polyols such as polyethylene glycol.

Preferred quaternary ammonium-based compounds optional but potentially preferred within the above-discussed inventive compositions and/or methods are acyclic quaternary ammonium salts, ditallowdimethyl ammonium chloride being most preferred. It may be appreciated that various combinations of fabric softening components may be used by the skilled artisan without departing from the scope of the present invention.

About 3-50% of the quaternary ammonium compounds and additives thereto are active within the fabric softener compositions of the invention. There must be included at least a sufficient amount of the inventive non-nitrogenated compounds, plus optional cationic fabric softening compounds, to achieve anti-static effect, for example, 3% in the dilute product and at least 5% in the concentrated product. On the other hand, the entire fabric softening component may be the inventive non-nitrogenated fabric softening compound [of component 3), above]. The diluted version of the product contains about 3% to 12%, preferably 4% to 7% of the inventive plus cationic fabric softening component, based on % active. The concentrated version of the product contains 13% to 50%, preferably 13% to 30% of the fabric softening component, based on % active.

The fabric softening compositions of the present invention include a liquid carrier, which is water and which may additionally contain up to 5% organic solvents such as lower alcohols selected from, for example, methyl alcohol, ethyl alcohol, isopropanol, and butanol, or glycols, such as propylene glycol, diethylene glycol, and hexylene glycol. Both the diluted and the concentrated versions of the product are preferably dispersions of the active ingredients in the water solvent matrix. The organic solvents can improve handling, fluidity and viscosity.

According to the present invention the pH of the liquid fabric softener compositions is less than 7, and is preferably in the range of from 4 to 6.5. Typically, there is no need to adjust pH of the compositions. However, if there is a need to adjust pH of the compositions, any acidic material may be used. Examples of suitable acids include hydrochloric, sulfuric, phosphoric, citric, maleic acids and the like. The pH is measured by a glass electrode in comparison with a standard calomel reference electrode.

Various additives may be optionally employed in amounts of 0.1% to 30% in the conditioning compositions of the present invention which increase performance, formulation range and stability, or which aid in dispersibility, viscosity control, and soil release. These include silicones, such as predominantly linear polydialkylsiloxanes, e.g., polydimethylsiloxanes; soil release polymers such as block copolymers of polyethylene oxide and terephthalate fatty amines selected from the group consisting of primary fatty amines, secondary fatty amines, tertiary fatty amines and mixtures thereof; amphoteric surfactants; smectite type inorganic clays; anionic soaps; zwitterionic quaternary ammonium compounds and nonionic surfactants. Nonionic additives include fatty alcohols; linear, secondary, branched, olefinic, and alkylphenol alcohol ethoxylates; mono- and di-glycerides; sorbitans; and ion pairs of anionic detergent surfactant and fatty amines. Cationic additives include monoalkyl trimethyl quaternary; ethoxylated amines; ethoxylated monoalkyl quaternary salts. Polymer additives include polyethylene oxide, polypropylene oxide, terephthalate, cyclodextrin, and guar gum. Electrolytes may be added for viscosity control in amounts of up to 5%, preferably in the range from 5 to 500 ppm. Such materials include Group IA and IIA halides, e.g., CaCl₂, MgCl₂ and NaCl, as well as alkylene polyammonium salts.

Preservatives in amounts up to 0.1% may be added to the fabric softening composition of the present invention in order to protect against microbial degradation. Such preservatives include glutaraldehyde, formaldehyde, 2-bromo-2-nitropropane-1,3-diol, and 5-chloro-2-methyl-4-isothiazolin-3-one/2-methyl-4-isothiazoline-3-one.

Further optional ingredients include emulsifiers, opacifiers, anti-shrink agents, anti-wrinkle agents, fabric crisping agents, spotting agents, antioxidants, anti-corrosion agents, optical brighteners or fluorescent agents preferably in the range from 0.01 to 5%, buffers, perfumes preferably from 0.1 to 5%, germicides, bactericides, and bacteriostatic agents. Bacteriostatic agents are preferably employed in the range from 1 to 1000 ppm.

It can be particularly desirable to include in the inventive compositions deodorant perfumes, e.g., those disclosed in U.S. Pat. No. 4,134,838. According to the present invention, the compositions preferably include from 0.01% to 10%, preferably 0.1% to 1% by weight of any suitable deodorant perfume, such as that described in the '838 patent.

The liquid fabric conditioning compositions can be prepared by conventional methods. A convenient and satisfactory method is to prepare the softening active premix (of either the non-nitrogenated compounds alone or plus the cationic compounds, or separately prepared and mixed together) at 50-80° C., which is added with stirring to the hot water. Temperature-sensitive components can be added after the fabric softening composition is cooled to a lower temperature. Additional additives, such as perfumes, colorants, etc., may be added to the composition at anytime during its preparation. The inventive fabric softening compositions can thus be and preferably are used in the rinse cycle of a conventional home laundry operation. Generally, rinse water has a temperature of from 5 to 60° C. The concentration of the total active ingredients is generally from 2 ppm to 1000 ppm, preferably from 10 ppm to 500 ppm, by weight of the aqueous rinsing bath. When multiple rinses are used, the fabric conditioning compositions are preferably added to the final rinse.

As noted above, this inventive composition and/or method provides improvements over typical cationic (quaternary ammonium) fabric softening agents. The lubricating abilities on fabrics accorded through utilization of the non-nitrogenated compounds noted above, surprisingly have been found to provide at least three highly desirable characteristics, namely, increased static dissipative capabilities, excellent softening levels, and decreased surface friction measurements (for ease in ironing), for all different types of commonly used fibers (cotton, polyester, nylon, blends, etc.). These benefits are apparent either when applied singly as an active fabric treatment agent during the rinse cycle of a standard machine laundering process, or in the presence of quaternary ammonium softeners (to provide a synergistic improvement in each of these test areas over both types of compounds alone). Thus, the inventive compositions and methods provide, as shown below, a marked beneficial improvement within the fabric softening and treatment art to heretofore unattained levels.

Upon contact with the yarns and/or fibers of the target fabrics within the rinse cycle step, these compounds appear to, without intending to be bound to any specific scientific theory, contact with and become adhered to the fibers and/or yarns themselves. Upon contact and adhesion, it appears that such components reduce the friction of the roughened, frayed, etc., fibers and/or fibrils. When dried, the heat applied to the target fabric then aids in melt-transporting these compounds over the target fabric. The free electrons present within the large amount of oxygens within the compound appears to aid in dissipating static electrical charges very effectively. Furthermore, the plasticization characteristics of the inventive softening additives provide highly effective softening benefits (i.e., a soft and pliable surface hand to the target fabrics) after application thereto comparable to that effectuated by standard quaternary ammoniums types. Additionally, the lubricating abilities of such compounds appears to aid in facilitating furthering ironing by permitting the target fibers to become highly oriented as intended by the manufacturer, such that surface friction is reduced thereby. The specific fiber lubricants/plasticizers do not appear to easily evaporate or otherwise leave the fabric, yarn, and/or fiber surface, and therefore remains attached thereto providing effective yarn friction reduction over the duration of such contact and adhesion to impart the desired surface friction reduction over an appreciable amount of time, all without contributing a greasy or otherwise undesirable feel to the target fabric surface. Thus, such a simple, cost-effective, easy-to-use, environmentally friendly, composition is a significant improvement in this industry, particular when it synergistically functions in combination with typical quaternary ammonium fabric softening compounds as well.

The term “rinse cycle” is intended to encompass the application of such compositions to target fabrics within, as noted throughout above, a standard mechanical rotary fabric washing machine, specifically during the cycle known as the rinse cycle [e.g., after washing through vigorous rotary movement of target fabrics in the presence of a detergent in order to remove excess high pH (potentially skin irritating) detergent from the wash basin and/or to wash residual high pH detergent from the target fabrics themselves]. Thus, the inventive method requires addition of the compositions above (either the non-nitrogenated compounds, above, alone or in the presence of quaternary ammonium softening agents) to such a wash step during a standard mechanical laundering process. In such a manner, the liquid compositions may be most effectively applied to the target fabrics in order to accord the highest level of beneficial static reduction, surface friction reduction, and softening increases.

The target fabrics may be of any type that exhibits a propensity for static build-up, surface roughening, surface wrinkling, etc., including those made from cotton, polyester, polyamide, ramie, wool, linen, and the like, as well as blends made therefrom.

The invention may be further understood by reference to the following examples, but is not intended to be unduly limited thereby.

### DESCRIPTION OF THE PREFERRED EMBODIMENT

Some particularly preferred compounds are listed below in the following table (EO represents ethylene oxide; and CO represents castor oil):

### Preferred Fiber Lubricant/Plasticizer Components

| Ex. | Chemical Structure andlor Tradename; Supplier; HLB # |
|---|---|
| 1 | CO (200 EO) (Syn Lube ® 106; Milliken & Company) (18.3) |
| 2 | Coco ester of CO (16 EO) (SynLube ® 1632H) (8.2) |
| 3 | Oleic acid diester of CO (27EO) (Syn Lube ® 728) (9.4) |
| 4 | Stearic Acid (15 EO) (Leveler ® 528; Milliken) (14.0) |
| 5 | Stearic Acid (5 EO) (11.1) |

Of particular interest are those compounds that exhibit an HLB of greater than or equal to 6.0. Such compounds mix well with a water carrier and any added quaternary ammonium of similar solubility in order to provide a more effective fiber penetrating rinse cycle softening additive.

The compositions noted in the Table of Preferred Fiber Lubricant/Plasticizer compounds were then applied to certain fabric types, namely cotton terry towels, 50/50 polyester cotton sheeting fabrics, 100% polyester sheers, and 100% nylon socks, for analysis of static dissipation, softening abilities, and surface friction (ironability) after first washing with Liquid Tide®-brand detergent (in an amount up to the line of the dosage cup). After this initial wash cycle, the softening agents were then added during the rinse cycle of the same wash process. Thus, compound 1 of the Table noted above was either used alone or mixed with Ultra Downy®-brand rinse cycle added fabric softener compositions for such purposes. Also, comparisons of the commercially available Ultra Downy®-brand Softener and control (no softener additives) were undertaken as well. The test fabrics were all washed under the same conditions and within the same washing machine (specific settings). 35 grams (recommended dosage up to the line of the cup or ball level) of the softening additives (in accordance with the table below) were then added during the final rinse cycle of the procedure. After completion of the washing procedure, the fabrics were then placed within a standard tumble dryer (Regular heat) and removed after 45 minutes. The tests were then made as noted. The test fabric softening compositions were as follows (the amount active for the quaternary ammonium, believed to be either Adogen 470™ or DEETMAC when present within Ultra Downy®-brand softener, is ⅕^{th} of the total amount added; the amount active for the fiber lubricant is the same as the amount added):

Preferred And Comparative Fabric Softener Compositions

| | Inventive Fiber | | |
|---|---|---|---|
| Ex. | Lubricant (wt) | Quaternary Ammonium | (% by wt) |
| 13 | Example 2, from | | |
| | above (7 grams) | | |
| 14 | same (3.5 grams) | Ultra Downy ®-brand Softener | (17.5 grams) |
| 15 | same (3 grams) | — | |
| 16 | same (5 grams) | — | |
| 17 | same (7 grams) | | |
| 18 | same (2 grams) | Ultra Downy ®-brand Softener | (25 grams) |
| 19 | same (3.5 grams) | Ultra Downy ®-brand Softener | (17.5 grams) |
| 20 | same (5 grams) | Ultra Downy ®-brand Softener | (10 grams) |

(Comparatives)

| | | | |
|---|---|---|---|
| 21 | — | — | (control) |
| 22 | — | Ultra Downy ®-brand Softener | (35 grams) |

The test protocols for static dissipation, surface friction, and softening, and results for each thereof, were as follows:

### Static Dissipation

Sample fabrics (100% nylon socks, 100% polyester sheers) were put through the above-described wash procedure (with the softener added during the rinse cycle thereof) and then dried for 45 minutes on regular heat setting. The fabrics were then removed from the dryer and empirically tested for static effects. The results were as follows:

EXPERIMENTAL TABLE 1

| Softener Composition | Static Evaluation |
|---|---|
| Example 13 | Socks did not cling to sheers; No crackling noise |
| Example 14 | Socks did not cling to sheers; No crackling noise |
| Example 21 | Socks clung to sheers; Loud crackling noise upon |
| | separation |
| Example 22 | Socks did not cling to sheers; Minimal crackling |
| | noise upon |
| | separation |

Thus, the inventive compositions provided improved static dissipation over the comparatives.

### Surface Friction

In accordance with a modified ASTM Test Method D 1894-93 “Standard Test Method for Static and Kinetic Coefficients of Friction of Plastic Film and Sheeting”, wherein a block of 200 grams and not wrapped in foam or film was pulled horizontally in both the warp and fill directions of 50/50 polyester/cotton sheeting samples of 6 inches by 11 inches. The dynamic and static load of each sample was measured by pulling the bloack over each sample 3 separate times and taking the average of the tension (and thus force) required to drag the block across a level fabric sample. The results were as follows (with a lower measurement indicating a lower friction required for sled movement, thus indicating ease in ironability):

EXPERIMENTAL TABLE 2

| | |
|---|---|
| Dynamic Load | Static Load |

| Softener Composition | Warp | Fill | Warp | Fill |
|---|---|---|---|---|
| Example 13 | 0.415 | 0.386 | 0.487 | 0.429 |
| Example 15 | 0.489 | 0.461 | 0.518 | 0.496 |
| Example 16 | 0.437 | 0.432 | 0.462 | 0.500 |
| Example 18 | 0.389 | 0.441 | 0.439 | 0.469 |
| Example 19 | 0.391 | 0.388 | 0.455 | 0.439 |
| Example 20 | 0.243 | 0.246 | 0.275 | 0.264 |
| Example 21 | 0.421 | 0.478 | 0.418 | 0.501 |
| Example 22 | 0.530 | 0.508 | 0.584 | 0.563 |

Thus, the inventive compositions again provided improved friction levels as compared with no additives or the standard quaternary types alone.

### Fabric Softening Measurements

Testing for softening was undertaken via hand-feel empirical analysis for a panel of seven persons. Samples of same color (beige) 100% cotton terry towels were washed in accordance with the procedure specified above and placed on a table with random labels (A-D) given to each. Each person then determined softness and greasy surface feel individually and rated each sample accordingly versus the others. A was Example 22; B was Example 19; and C was Example 18, all from above. The results were as follows:

EXPERIMENTAL TABLE 3

| Softness | Evaluation | Greasiness | Evaluation |
|---|---|---|---|
| A versus C | 1 for A; 6 for C | A versus C | 4 for A; 3 for C |
| A versus B | 6 for A; 1 for B | A versus B | 7 for A; 0 for B |
| C versus B | 7 for C; 0 for B | C versus B | 4 for C; 3 for B |

Thus, the inventive compositions showed comparable softening and greasiness results as the standard quaternary types, indicating acceptability as additives or softening agents alone.

There are, of course, many alternative embodiments and modifications of the present invention which are intended to be included within the spirit and scope of the following claims.

What I claim is:

1. A fabric softener composition comprising:
1) from 0.1 to 90% by weight of at least one cationic fabric softener compoun;
2) from 0.001 to about 99.99% by weight of a liquid carrier;
3) and at least one fiber lubricant/plasticizer selected from the group of lubricating/plasticizing agents consisting of at least one compound that conforms with the following Formula (A) 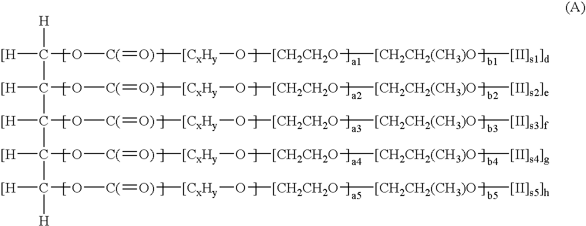
wherein d=f=h=1; e=0 or 1; g=0 or 1; 2≦x≦20; (2x−4)≦y≦2x; and Σaᵢ>=8 and
$$\frac{Σ {a}_{i} ( 44 )}{Σ {a}_{i} ( 44 ) + Σ {b}_{i} ( 56 )} >= 0.6 ;$$
wherein structure [II] is H, CH₃, or 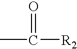
wherein R₂=CₚH_{q} such that 1≦p≦20, 2p−3≦q≦2p+1, and sᵢ=0 or 1; at least one compound that conforms with the following Formula (B)
(B)
[I]—[CH₂CH₂O—]ₐᵢ—[CH₂CH₂(CH₃)O—]_{bi}—[II]ₛᵢ
wherein structure [I] is H, CH₃O, or R₁(O)_{c};
wherein R₁=CₙHₘ, and 2≦n≦20, (2n−4)≦m≦2n+1, 1≦c≦5, and Σaᵢ≧8, and
$$\frac{Σ {a}_{i} ( 44 )}{Σ {a}_{i} ( 44 ) + Σ {b}_{i} ( 56 )} >= 0.6 ;$$
wherein and Structure [II] is H, CH₃, or 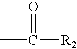
wherein R₂=CₚH_{q} such that 1≦p≦20, 2p−3≦q≦2p+1, and sᵢ=0 or 1; and any mixtures thereof.

2. The composition of claim 1 wherein said cationic fabric softener compound is a quaternary ammonium-based compound.

3. A method of treating fabrics during a standard laundering procedure comprising the steps of:
a) providing a fabric within a rinse cycle of a standard mechanical rotary washing machine;
b) producing a fabric softening composition within said rinse cycle, wherein said fabric softening composition comprises:
3) from 0 to 90% by weight of at least one cationic fabric softener compound;
4) from 0.001 to about 99.99% by weight of a liquid carrier;
3) and at least one fiber lubricant/plasticizer selected from the group of lubricating/plasticizing agents consisting of at least one compound that conforms with the following Formula (A) 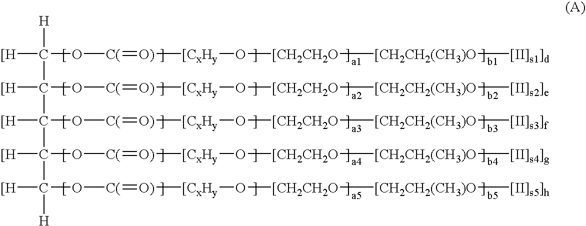
wherein d=f=h=1; e=0 or 1; g=0 or 1; 2≦x≦20; (2x−4)≦y≦2x; and Σaᵢ>=8 and
$$\frac{Σ {a}_{i} ( 44 )}{Σ {a}_{i} ( 44 ) + Σ {b}_{i} ( 56 )} >= 0.6 ;$$
wherein structure [II] is H, CH₃, or 0 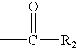
wherein R₂=CₚH_{q} such that 1≦p≦20, 2p−3≦q≦2p+1, and sᵢ=0 or 1; at least one compound that conforms with the following Formula (B)
(B)
[I]—[CH₂CH₂O—]ₐᵢ—[CH₂CH₂(CH₃)O—]_{bi}—[II]ₛᵢ
wherein structure [I] is H , CH₃O, or R₁(O)_{c};
wherein R₁=CₙHₘ, and 2≦n≦20, (2n−4)≦m≦2n+1, 1≦c≦5, and Σaᵢ≧8 and
$$\frac{Σ {a}_{i} ( 44 )}{Σ {a}_{i} ( 44 ) + Σ {b}_{i} ( 56 )} >= 0.6 ;$$
wherein and Structure [II] is H, CH₃, or 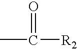
wherein R₂=CₚH_{q} such that 1≦p≦20, 2p−3≦q≦2p+1, and sᵢ=0 or 1; and any mixtures thereof.

4. The method of claim 3 wherein said cationic fabric softener compound is a quaternary ammonium-based compound.

5. A fabric treated by the method of claim 3.
